(19) United States
(12) Patent Application Publication
(10) Pub. No.: US 2007/0086835 A1
(43) Pub. Date: Apr. 19, 2007

(54) Ring Mechanism for ring binder

(75) Inventor: Donald Grant Smith, Mundelein, IL (US)

Correspondence Address: MICHAEL BEST & FRIEDRICH, LLP, 100 EAST WISCONSIN AVENUE, SUITE 3300, MILWAUKEE, WI, 53202, US

(73) Assignee: ACCO Brands USA LLC, Lincolnshire, IL (US)

(21) Appl. No.: 11/231,731

(22) Filed: Sep. 21, 2005

(51) Int. Cl. B42F 13/02

(52) U.S. Cl. 402/19

(57) ABSTRACT

The present invention provides a ring mechanism including a chassis and a hinge blade coupled to the chassis. The hinge blade is movable between a first position and a second position. The ring mechanism also includes a ring half coupled to the hinge blade. The ring half is movable between a closed position when the hinge blade is in the first position, and an open position when the hinge blade is in the second position. The ring mechanism further includes at least one eyelet coupled with the chassis. The at least one eyelet includes a body portion extending away from the chassis and having a terminal end lying in a plane. The terminal end is configured to engage a mounting surface of a binder. The eyelet also includes a rim portion coupled to the terminal end of the body portion. The rim portion extends away from the plane toward the chassis.

### FIELD OF THE INVENTION

The present invention relates to ring binders, and more particularly to ring mechanisms for ring binders.

### BACKGROUND OF THE INVENTION

FIG. 1a illustrates a prior art ring mechanism 10 coupled to a spine 14 of a binder. The ring mechanism 10 includes a substantially rigid chassis 18 and two hinge blades 22 that are pivotable with respect to the chassis 18. A plurality of ring elements or ring halves 26 are coupled to the hinge blades 22 for movement with the hinge blades 22. An eyelet 30 is positioned in an aperture 34 in the chassis 18. One end of the eyelet 30 is deformed to secure the eyelet 30 to the chassis 18, while the other end of the eyelet 30 commonly includes a rim 38 configured to engage the spine 14 of the binder. A rivet 42 is positioned in an aperture 46 in the spine 14 of the binder and an aperture 48 in the eyelet 30. A tail portion 50 of the rivet 42 is deformed to secure the eyelet 30, and thus the ring mechanism 10, to the spine 14.

### SUMMARY OF THE INVENTION

As shown in FIGS. 1a-1c, the rim 38 of the eyelet 30 extends beyond the lowermost extents of the hinge blades 22 and the chassis 18. When such prior-art ring mechanisms 10 are packaged one on top of another, the eyelets 30 of lower ring mechanisms 10 often hook onto crimped edges 54 of the chassis 18 of higher ring mechanisms 10 (see FIG. 1b). Also, when such prior-art ring mechanisms 10 are packaged one on top of another, the eyelets 30 of lower ring mechanisms 10 often hook onto eyelets 30 of higher ring mechanisms 10 (see FIG. 1c). Having to separate hooked ring mechanisms 10 increases the time required to manually unpack the stacked ring mechanisms 10, and increases the complexity of automating the process of unpacking of stacked ring mechanisms 10.

The present invention provides, in one aspect, a ring mechanism including a chassis and a hinge blade coupled to the chassis. The hinge blade is movable between a first position and a second position. The ring mechanism also includes a ring half coupled to the hinge blade. The ring half is movable between a closed position when the hinge blade is in the first position, and an open position when the hinge blade is in the second position. The ring mechanism further includes at least one eyelet coupled with the chassis. The at least one eyelet includes a body portion extending away from the chassis and having a terminal end lying in a plane. The terminal end is configured to engage a mounting surface of a binder. The at least one eyelet also includes a rim portion coupled to the terminal end of the body portion. The rim portion extends away from the plane toward the chassis.

The present invention provides, in another aspect, a ring mechanism adapted to be coupled to a mounting surface of a binder. The ring mechanism includes a chassis and a hinge blade coupled to the chassis. The hinge blade is movable between a first position and a second position. The ring mechanism also includes a ring half coupled to the hinge blade. The ring half is movable between a closed position when the hinge blade is in the first position, and an open position when the hinge blade is in the second position. The ring mechanism further includes at least one eyelet extending from the chassis. The at least one eyelet includes a rim having a first end engageable with the mounting surface, and a second end closer to the chassis than the first end. The second end is not engageable with the mounting surface.

The present invention provides, in yet another aspect, a method of assembling a ring mechanism. The method includes providing a chassis, pivotably coupling a hinge blade to the chassis, coupling a ring half to the hinge blade for movement with the hinge blade, and coupling at least one eyelet to the chassis. The at least one eyelet includes a body portion and a rim coupled to the body portion. Coupling the at least one eyelet to the chassis includes securing the body portion to the chassis and deforming the rim toward the chassis.

Other aspects of the invention will become apparent by consideration of the detailed description and accompanying drawings.

### BRIEF DESCRIPTION OF THE DRAWINGS

FIG. 1a is a cross-sectional view of a prior art ring mechanism coupled to a panel of a binder.

FIG. 1b is a cross-sectional view of two prior art ring mechanisms of FIG. 1a stacked upon one another.

FIG. 1c is another cross-sectional view of two prior art ring mechanisms of FIG. 1a stacked upon one another.

FIG. 2 is a top perspective view of a ring mechanism of the present invention exploded from a panel of a binder.

FIG. 3 is a top perspective view of the ring mechanism of FIG. 2 coupled to the panel of the binder.

FIG. 4 is a cross-sectional view of the ring mechanism and the panel taken through line 4-4 in FIG. 3.

FIG. 5a is cross-sectional view of the ring mechanism of FIG. 2, illustrating an eyelet being positioned in an aperture of a chassis.

FIG. 5b is a cross-sectional view of the ring mechanism of FIG. 2, illustrating the eyelet being deformed to couple the eyelet to the chassis.

FIG. 6 is a cross-sectional view of two ring mechanisms of FIG. 2 stacked upon one another

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

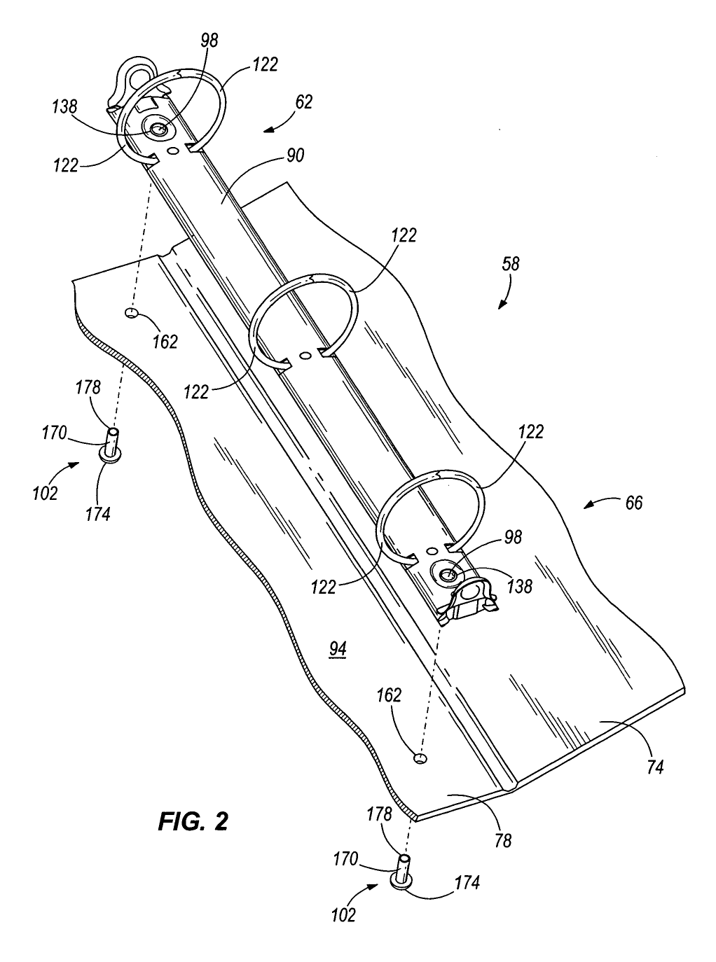

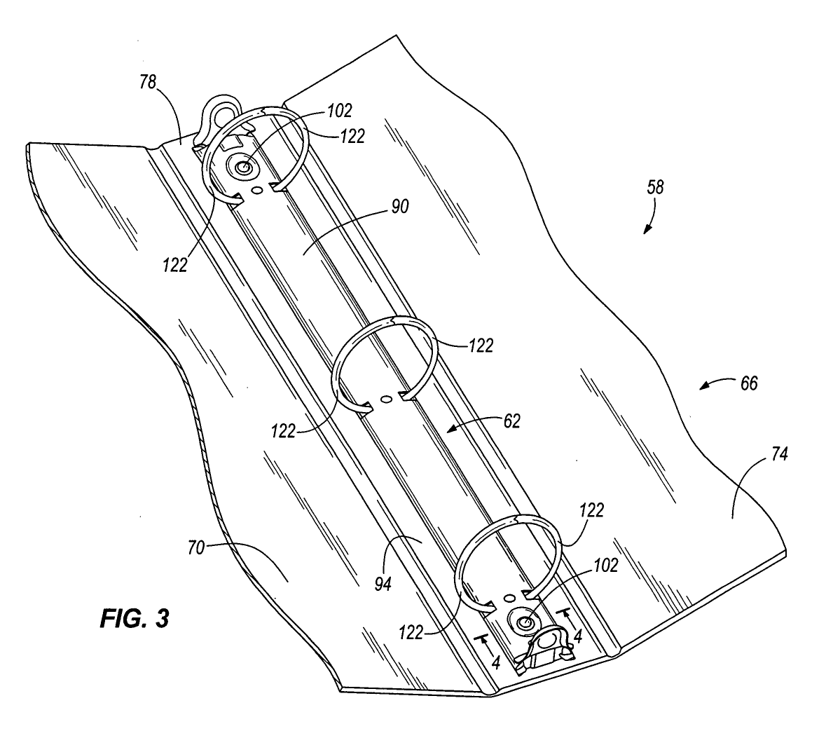

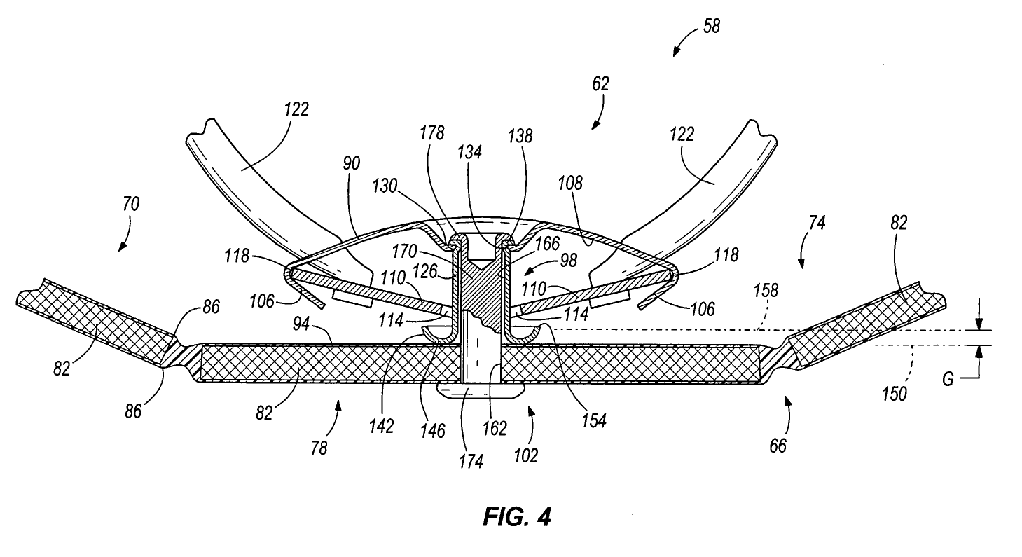

FIGS. 2 and 3 illustrate a ring binder 58 including a ring mechanism 62 of the present invention. The ring binder 58 includes a flat 66 having a plurality of coupled panels, particularly a front panel 70 and a rear panel 74. In illustrated construction, the front and rear panels 70, 74 are coupled by a spine 78 (see FIG. 3). It should be understood that in other constructions of the flat 66, the front and rear panels 70, 74 may be coupled together directly without the use of the spine 78. As shown in FIG. 4, the front panel 70, rear panel 74, and spine 78 each include a chipboard 82 sandwiched by vinyl layers 86. Further, the front panel 70, rear panel 74, and spine 78 may each include one-piece panels made from any of a number of different materials (e.g., plastic, cardboard, metal, etc.).

The ring mechanism 62 includes a plastic or metallic chassis 90 that is coupled to a mounting surface 94 of one of the front panel 70, rear panel 74, and spine 78 by at least one eyelet 98 and at least one rivet 102 (see FIG. 2). In the illustrated construction, the mounting surface 94 is located on the spine 78, and two eyelets 98 and two rivets 102 are utilized to secure the ring mechanism 62 to the spine 78. Alternatively, the mounting surface 94 may be located on either the front panel 70 or the rear panel 74, and more or less than two eyelets 98 and two rivets 102 may be utilized to secure the ring mechanism 62 to the flat 66. As used herein, the term “mounting surface” may include any surface on the flat 66 or any surface spaced from the flat 66 to which the ring mechanism 62 is secured. With reference to FIG. 4, the eyelet 98 directly engages or contacts the flat 66. Alternatively, a spacer may be used between the eyelet 98 and the flat 66 to space the chassis 90 from the flat 66.

With continued reference to FIG. 4, the ring mechanism 62 is shown in more detail. The chassis 90 includes bent or crimped edges 106 and an inner surface 108 extending between the crimped edges 106. The ring mechanism 62 also includes at least one hinge blade 110 coupled to the chassis 90. In the illustrated construction, two hinge blades 110 are pivotably coupled to the chassis 90. Alternatively, the ring mechanism 62 may only include a single hinge blade 110. Each hinge blade 110 includes an inner edge 114 and an outer edge 118. The hinge blades 110 are coupled to the chassis 90 such that the crimped edges 106 of the chassis 90 are folded over the respective outer edges 118 of the hinge blades 110. As the ring mechanism 62 is opened and closed, the hinge blades 110 pivot about their respective outer edges 118 such that the inner edges 114 move toward or away from the inner surface 108. The hinge blades 110 pivot from a first or closed position to a second or open position, in which the inner edges 114 are moved closer to the inner surface 108 of the chassis 90.

The ring mechanism 62 further includes at least one ring half 122 coupled to each hinge blade 110. Together, the ring halves 122 define a substantially closed ring that can be opened or closed. In the embodiments where only one hinge blade 110 is present in the ring mechanism 62, at least one ring half 122 is coupled to the hinge blade 110 and a corresponding ring half 122 is coupled to the chassis 90 such that the corresponding ring halves 122 still define a substantially closed ring. As shown in FIGS. 2 and 3, the hinge blades 110 each include three ring halves 122, but it should be understood that any number of ring halves 122 may be coupled to the hinge blades 110.

As shown in FIG. 4, the eyelet 98 includes a body portion 126 coupled to and extending away from the chassis 90. Specifically, the body portion 126 includes a ridge or a lip 130 formed around the periphery of the body portion 126. The body portion 126 is received in an aperture 134 in the chassis 90, and the lip 130 abuts the inner surface 108 of the chassis 90 to limit the insertion of the body portion 126 through the aperture 134. In the illustrated construction, the chassis 90 is coupled to an upper terminal end 138 of the body portion 126 by a rolling process which will be discussed in greater detail below. Alternatively, other processes may be used to couple the chassis 90 and the eyelet 98.

The eyelet 98 also includes a rim portion or a rim 142 coupled to a lower terminal end 146 of the body portion 126. As shown in FIG. 4, the lower terminal end 146 of the body portion 126 engages the spine 78 and lies in a first plane 150 substantially parallel with the mounting surface 94 on the spine 78. The rim 142 extends away from the first plane 150 and toward the hinge blades 110 and the chassis 90. Particularly, the rim 142 is bent upwardly from the first plane 150, such that a distal end 154 of the rim 142 lies in a second plane 158 located between the first plane 150 and the chassis 90. In the illustrated construction, the second plane 158 is spaced from the first plane 150 by a gap “G” of about 1 mm. Alternatively, the second plane 158 may be spaced from the first plane 150 between about 0.5 mm and about 2 mm.

With continued reference to FIG. 4, the rivet 102 is received in respective apertures 162, 166 in the spine 78 and the eyelet 98 to couple the ring mechanism 62 to the spine 78. In the illustrated construction, the rivet 102 includes a body portion 170 extending through the apertures 162, 166 and a head 174 abutting the spine 78. A tail end 178 of the rivet 102 is deformed against the upper terminal end 138 of the eyelet 98 to secure the spine 78 and the eyelet 98 between the deformed tail end 178 of the rivet 102 and the head 174 of the rivet 102. Alternatively, other configurations of rivets may be utilized to couple the ring mechanism 62 to the spine 78.

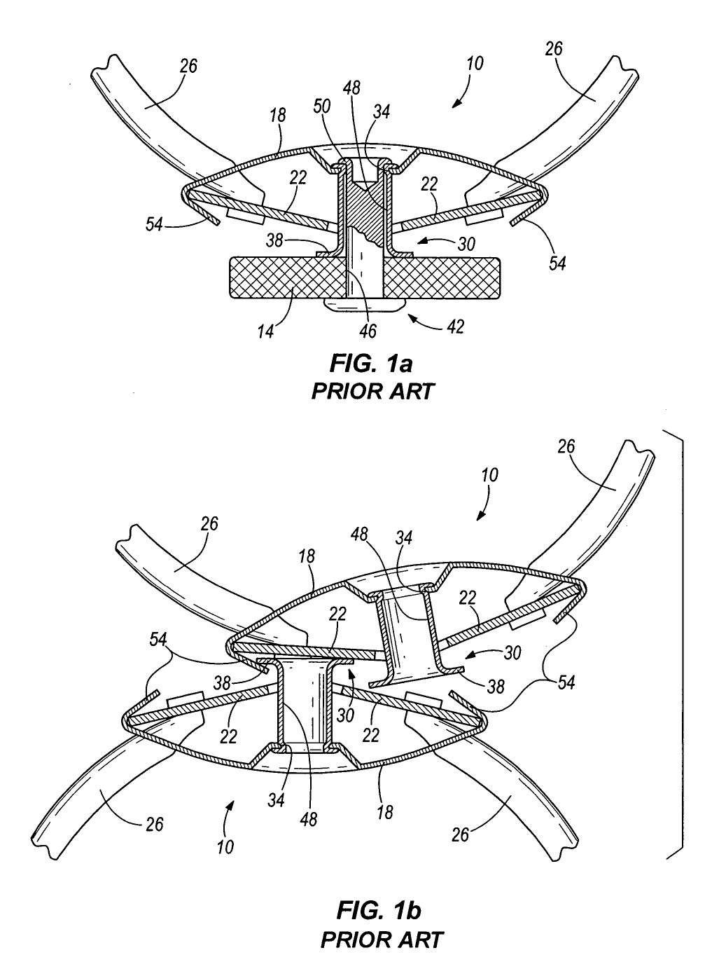

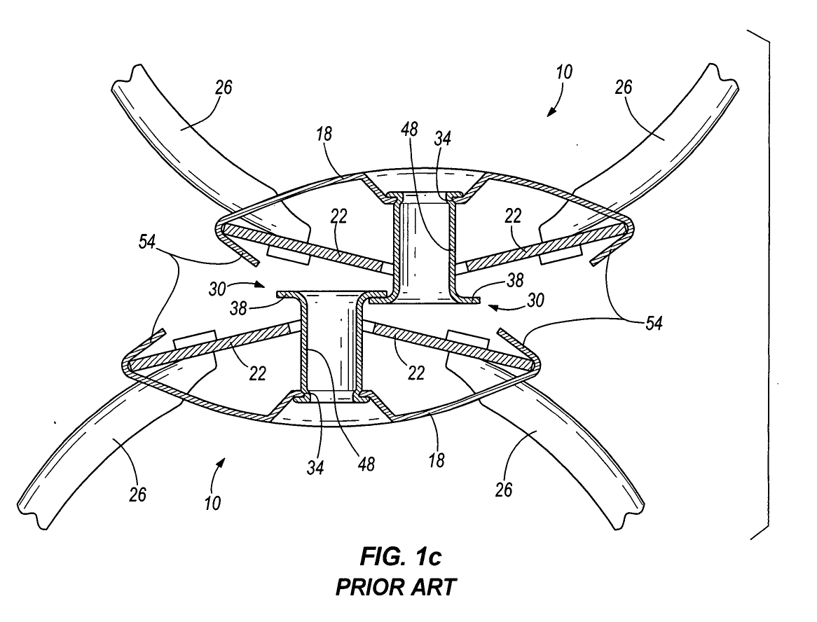

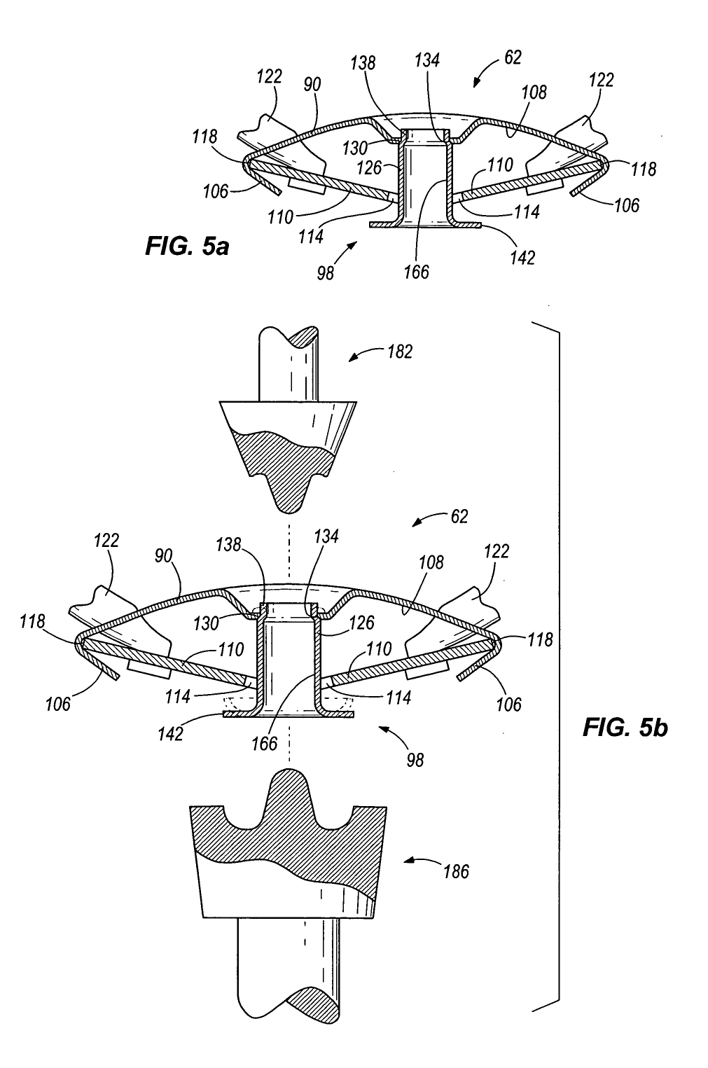

The ring mechanism 62 of FIGS. 2-6 may be assembled in a similar manner as the prior art ring mechanism 10 of FIGS. 1a and 1b. Particularly, the ring halves 122 may be coupled to the hinge blades 110, and the hinge blades 110 may be coupled to the chassis 90 in a similar manner as the ring halves 26, hinge blades 22, and chassis 18 of the prior art ring mechanism 10. However, with reference to FIGS. 5a and 5b, additional processes are performed on the eyelets 98 that are not performed on the eyelets 30 of the prior art ring mechanism 10. As shown in FIG. 5a, the upper terminal end 138 of the body portion 126 of the eyelet 98 may be inserted through the aperture 134 of the chassis 90 until the lip 130 abuts the inner surface 108 of the chassis 90. With reference to FIG. 5b, a first die 182 may be utilized to deform or roll the upper terminal end 138 of the body portion 126 to couple the eyelet 98 to the chassis 90. Particularly, the first die 182 may roll the upper terminal end 138 of the body portion 126 to pinch the chassis 90 around the outer periphery of the aperture 134 between the upper terminal end 138 of the body portion 126 and the lip 130. Although the first die 182 is illustrated schematically in FIG. 5b, the first die 182 may be configured in any of a number of different ways to deform or roll the upper terminal end 138 of the body portion 126 to pinch the chassis 90 around the outer periphery of the aperture 134.

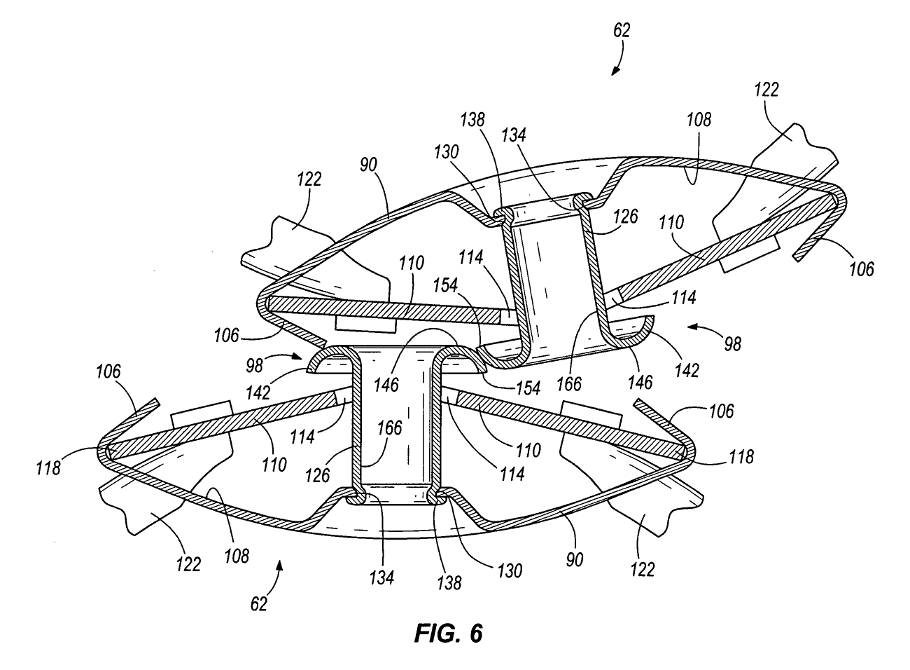

A second die 186 may be utilized to roll or bend the rim 142 upwardly toward the chassis 90. Like the first die 182, the second die 186 is shown schematically in FIG. 5b and may be configured in any of a number of different ways to bend the rim 142 toward the chassis 90. In the illustrated construction, the first and second dies 182, 186 act on the eyelet 98 at about the same time to roll the upper terminal end 138 of the body portion 126 and bend the rim 142 toward the chassis 90. Alternatively, the first and second dies 182, 186 may act on the eyelet 98 at different times during the process of assembling the ring mechanism 62. Additionally, the eyelet 98 could be provided for the assembly process with the rim 142 already deformed as shown in FIGS. 4 and 6.

With reference to FIG. 6, two ring mechanisms 62 are shown stacked upon one another. Unlike the prior art ring mechanisms 10, which commonly would hook onto adjacent ring mechanisms 10 when packaged as shown in FIGS. 1b and 1c, the ring mechanism 62 of FIGS. 2-6 is substantially prevented from hooking onto an adjacent ring mechanism 62 when packaged. As shown in FIG. 6, the bent rims 142 of the eyelets 98 are substantially prevented from hooking onto the bent rims 142 of adjacent ring mechanisms 62, or the crimped edges 106 of adjacent chassis 90. Instead, the adjacent bent rims 142 will slide over one another without becoming hooked or caught on one another. As a result, less time may be required to manually unpack the stacked ring mechanisms 62. In addition, automating the process of unpacking of stacked ring mechanisms 62 may be simplified.

Various features and aspects of the invention are set forth in the following claims.

What is claimed is:

1. A ring mechanism comprising:
a chassis;
a hinge blade coupled to the chassis, the hinge blade being movable between a first position and a second position;
a ring half coupled to the hinge blade, the ring half being movable between a closed position when the hinge blade is in the first position, and an open position when the hinge blade is in the second position;
at least one eyelet coupled with the chassis, the at least one eyelet including
a body portion extending away from the chassis and having a terminal end lying in a plane, the terminal end configured to engage a mounting surface of a binder; and
a rim portion coupled to the terminal end of the body portion, the rim portion extending away from the plane toward the chassis.

2. The ring mechanism of claim 1, wherein the rim portion is bent from the terminal end toward the chassis.

3. The ring mechanism of claim 1, wherein the terminal end is adapted to be engaged with a mounting surface of a binder, and wherein the rim portion is adapted to be spaced from the mounting surface.

4. The ring mechanism of claim 1, wherein the plane containing the terminal end is a first plane, and wherein the rim portion includes a distal end lying in a second plane spaced from the first plane.

5. The ring mechanism of claim 4, wherein the second plane is positioned between the first plane and the chassis.

6. The ring mechanism of claim 4, wherein the first plane is spaced from the second plane between about 0.5 mm and about 2 mm.

7. The ring mechanism of claim 4, wherein the second plane is substantially parallel with the first plane.

8. The ring mechanism of claim 1, wherein the at least one eyelet is received in and coupled to an aperture in the chassis.

9. A ring mechanism adapted to be coupled to a mounting surface of a binder, the ring mechanism comprising:
a chassis;
a hinge blade coupled to the chassis, the hinge blade being movable between a first position and a second position;
a ring half coupled to the hinge blade, the ring half being movable between a closed position when the hinge blade is in the first position, and an open position when the hinge blade is in the second position;
at least one eyelet extending from the chassis, the at least one eyelet including a rim having
a first end engageable with the mounting surface; and
a second end closer to the chassis than the first end, the second end not engageable with the mounting surface.

10. The ring mechanism of claim 9, wherein the first end lies in a plane substantially parallel with the mounting surface, and wherein the rim extends away from the plane toward the chassis.

11. The ring mechanism of claim 10, wherein the plane containing the first end is a first plane, and wherein the second end lies in a second plane spaced from the first plane.

12. The ring mechanism of claim 11, wherein the second plane is positioned between the first plane and the chassis.

13. The ring mechanism of claim 11, wherein the first plane is spaced from the second plane between about 0.5 mm and about 2 mm.

14. The ring mechanism of claim 11, wherein the second plane is substantially parallel with the first plane.

15. The ring mechanism of claim 9, wherein the at least one eyelet is received in and coupled to an aperture in the chassis.

16. A method of assembling a ring mechanism, the method comprising:
providing a chassis;
pivotably coupling a hinge blade to the chassis;
coupling a ring half to the hinge blade for movement with the hinge blade; and
coupling at least one eyelet to the chassis, the at least one eyelet including a body portion and a rim coupled to the body portion;
wherein coupling the at least one eyelet to the chassis includes securing the body portion to the chassis and deforming the rim toward the chassis.

17. The method of claim 16, wherein deforming the rim includes bending the rim out of a first orientation in which the rim lies substantially entirely in a first plane.

18. The method of claim 17, wherein deforming the rim includes bending the rim to a second orientation in which a portion of the rim lies in a second plane positioned between the first plane and the chassis.

19. The method of claim 16, wherein securing the body portion and deforming the rim occurs at substantially the same time.

20. The method of claim 16, wherein deforming the rim occurs prior to securing the body portion to the chassis.
